(19) United States
(12) Patent Application Publication
(10) Pub. No.: US 2016/0098092 A1
(43) Pub. Date: Apr. 7, 2016

(54) DISPLAY APPARATUS AND METHOD FOR CONTROLLING THE SAME

(71) Applicant: SAMSUNG ELECTRONICS CO., LTD., Suwon-si (KR)

(72) Inventors: Woo-seok HWANG, Seoul (KR); Yong-hwan KWON, Seongnam-si (KR); Ji-eun KIM, Suwon-si (KR); Ji-woo SUH, Seoul (KR); Yoo-jin CHOI, Seoul (KR)

(21) Appl. No.: 14/848,778

(22) Filed: Sep. 9, 2015

(30) Foreign Application Priority Data
Oct. 2, 2014 (KR) 10-2014-0133502

(51) Int. Cl. G06F 3/01; H04N 5/44

(52) U.S. Cl. CPC G06F 3/017; H04N 5/4403; H04N 2005/4407; H04N 2005/4428; H04N 2005/443

(57) ABSTRACT

A display apparatus is provided. The display apparatus includes a display configured to display information, a detector configured to detect a signal according to a motion of a control subject, and a controller configured to, in response to a signal according to a predetermined motion of the control subject being detected, control to change an amount of the displayed information and provide the information. Accordingly, user convenience may be enhanced since a user is able to change the amount of information through a simple manipulation

### CROSS-REFERENCE TO RELATED APPLICATION

This application is based on and claims priority under 35 U.S.C. §119 to Korean Patent Application No. 10-2014-0133502, filed on Oct. 2, 2014 in the Korean Intellectual Property Office, the disclosure of which is incorporated herein by reference in its entirety.

### BACKGROUND

1. Field

The example embodiments generally relate to a display apparatus and a method for controlling the same, and for example, to a display apparatus which changes an amount of displayed information and provides the information and a method for controlling the same.

2. Description of Related Art

With the development of electronic technologies, various types of electronic apparatuses have been developed and have come into wide use. Specially, various display apparatuses, such as, a television (TV), a mobile phone, a Personal Computer (PC), a laptop PC, a Personal Digital Assistant (PDA), a tablet PC, and the like, are widely used in most households.

According to the increasing use of the display apparatuses, there is need for diverse input methods for effectively using various functions of the display apparatuses. For example, diverse input methods of using a remote controller, a mouse, or a touch pad are being applied to the display apparatuses.

However, such simple input methods are not enough for a user to use diverse functions of the display apparatuses effectively. For example, according to the development of the technologies related to a smart TV and the increase of various contents provided by a service provider, a configuration of a user interface (UI) screen has become more complicated than a configuration of existing UI screens, and thus, a user is not able to easily retrieve or select desired content through simple manipulation. Accordingly, there is a need for a method of retrieving content more easily than the existing manipulation of, for example, pressing a button several times.

In addition, when the service provider changes only a depth in providing various contents, the user is not able to easily check information on the contents. For example, the user is not able to specifically check information corresponding to the content in the same depth and needs to enter into a lower depth in order to check the information corresponding to the content.

### SUMMARY

Example embodiments have been provided to address the aforementioned and other problems and disadvantages occurring in the related art, and an aspect of the example embodiments provides a display apparatus which changes an amount of displayed information and provides the information based on a signal based on a motion of a control subject.

According to an example embodiment, a display apparatus is provided including: a display configured to display information, a detector (e.g., a motion detector) configured to detect a signal based on a motion of a control subject, and a controller configured to, in response to a signal based on a predetermined motion of the control subject being detected, control the display to change an amount of the displayed information and provide the information.

The detector (e.g., a motion detector) may, for example, receive a signal corresponding to a motion of a remote controller having a motion sensor. In addition, in response to a signal based on a forward motion or a backward motion of the remote controller being received, the controller may be configured to control the display to change the amount of the displayed information and provide the information.

The signal corresponding to the motion of the remote controller may, for example, be a signal corresponding to a predetermined motion of the remote controller, the predetermined motion being detected while a predetermined button of the remote controller is pressed.

The detector may be configured to receive a signal from a remote controller having a touch pad. In addition, in response to a signal based on a swipe interaction or other gesture on the touch pad being received, the controller may be configured to control the display to change the amount of the displayed information and to provide the information.

The detector may be configured to detect a user motion. In addition, in response to a forward motion or a backward motion of a user being detected, the controller may be configured to control the display to change the amount of the displayed information and to provide the information.

The amount of the displayed information may, for example, include at least one of the number, a size, and specific information of a content.

The specific information of the content may, for example, include at least one of a thumbnail, a title, a genre, and summary information of the content. In addition, in response to the number or amount of content being changed, the controller may be configured to change the size and the specific information of the content and to provide the content based on the changed number or amount of content.

The controller may be configured to determine an amount of information which varies depending upon the detected signal based on at least one of resolution information and size information on a screen of the display apparatus.

The display may be configured to provide a screen having a depth structure. In addition, in response to the signal based on the predetermined motion of the control subject being detected while the amount of the displayed information satisfies a predetermined condition, the controller may be configured to change a depth and to provide information corresponding to the changed depth.

The depth structure may, for example, include a main category, a sub category provided in the main category, and a content provided in the sub category.

According to an example embodiment, a method for controlling a display apparatus is provided, the method including: displaying information and changing, in response to a signal based on a predetermined motion of a control subject being detected, an amount of the displayed information and providing the information.

In response to a signal based a forward motion or a backward motion being received from a remote controller having a motion sensor, changing the amount of the displayed information may include changing the amount of the displayed information and providing the information.

The signal being received from the remote controller may be a signal corresponding to a predetermined motion of the remote controller, the predetermined motion being detected while a predetermined button of the remote controller is pressed.

In response to a signal based on a swipe interaction or other gesture on a touch pad being received from a remote controller having a touch pad, changing the amount of the displayed information may include changing the amount of the displayed information and providing the information.

In response to a forward motion or a backward motion of a user being detected, changing the amount of the displayed information may include changing the amount of the displayed information and providing the information.

The amount of the information may include at least one of the number, a size, and specific information of a content.

The specific information of the content may include at least one of a thumbnail, a title, a genre, and summary information of a content. In addition, in response to the number of contents being changed, changing the amount of the information may include changing the size and the specific information of the content and providing the content based on the changed number of contents.

Changing the amount of the displayed information may include determining an amount of information which varies depending upon the detected signal based on at least one of resolution information and size information on a screen of the display apparatus.

The method may, for example, further include changing, in response to the signal based on the predetermined motion of the control subject being detected while the amount of the displayed information satisfies a predetermined condition, a depth and providing information corresponding to the changed depth.

The depth structure may include, for example, a main category, a sub category provided in the main category, and a content provided in the sub category.

According to the above-described various example embodiments, a display apparatus detects a signal based on a motion of a control subject, changes an amount of displayed information, and provides the information. Accordingly, user convenience may be enhanced since a user is able to change the amount of information through a simple manipulation.

### BRIEF DESCRIPTION OF THE DRAWINGS

The above and/or other aspects and advantages of the example embodiments will become more apparent from the following detailed description taken in conjunction with the accompanying drawings, in which like reference numerals refer to like elements, and wherein:

FIG. 1 is a view illustrating a display apparatus according to an example embodiment;

FIGS. 2A-2B are block diagrams illustrating a structure of a display apparatus according to an example embodiment;

FIGS. 3A-3C are views provided to describe an operation of changing an amount of displayed information and providing the information according to an example embodiment;

FIG. 4 is a view provided to describe a motion of a control subject according to an example embodiment;

FIG. 5 is a view provided to describe a motion of a control subject according to another example embodiment;

FIG. 6 is a view provided to describe a motion of a control subject according to still another example embodiment;

FIGS. 7A-7B are views provided to describe an operation of changing a depth according to an example embodiment;

FIGS. 8A-8C are views provided to describe an operation of changing an amount of displayed information and providing the information according to an example embodiment;

FIG. 9 is a view provided to describe an operation of selecting a layout according to an example embodiment; and

FIG. 10 is a flowchart provided to describe a method for controlling a display apparatus according to an example embodiment.

### DETAILED DESCRIPTION

The example embodiments may be diversely modified. Accordingly, example embodiments are illustrated in the drawings and are described in detail in the detailed description. However, it is to be understood that the disclosure is not limited to any specific example embodiment, but includes all modifications, equivalents, and substitutions without departing from the scope and spirit of the disclosure. Also, well-known functions or constructions are not described in detail since they would obscure the disclosure with unnecessary detail.

Certain example embodiments are described in greater detail below with reference to the accompanying drawings.

In the following description, like drawing reference numerals are used for like elements, even in different drawings. The matters defined in the description, such as detailed construction and elements, are merely illustrative and are provided to assist in an understanding of example embodiments. However, example embodiments can be practiced without those specifically defined matters. Also, well-known functions or constructions are not described in detail since they would obscure the application with unnecessary detail.

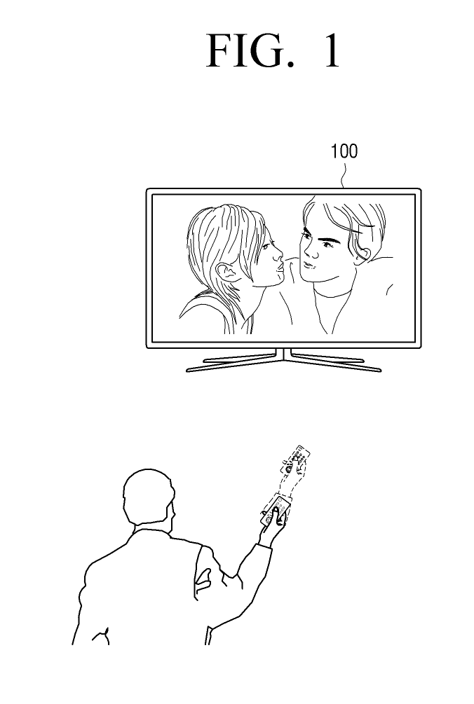

FIG. 1 is a view illustrating a display apparatus according to an example embodiment. As illustrated in FIG. 1, a user is able to control a display apparatus 100 through, for example, a motion of a remote controller, but is not limited thereto. The user is also able to control the display apparatus 100 through, for example, a user motion.

The display apparatus 100 may provide various information. For example, in response to the display apparatus 100 being turned on, the display apparatus 100 may provide a UI screen divided into main categories, such as, Movie, Education, Cook, etc. In response to ‘Movie’ category being selected by a user, the display apparatus 100 may display a UI screen divided into a plurality of sub categories, such as, Action, Romance, Horror, Comedy, etc., out of the ‘Movie’ category. In addition, in response to one of the sub categories being selected, a plurality of contents may be displayed, but is not limited thereto, and the categories may be divided by depth into sub-categories. The detailed description on a depth structure will be provided below.

The display apparatus 100 may provide the displayed information. For example, the display apparatus 100 may provide a main category and the contents. While a screen of the main category is selected, the display apparatus 100 may provide the UI screen divided into the main categories of Movie, Education, and Cook and may additionally provide a portion of information regarding a content corresponding to, for example, the Movie, a portion of information on a content corresponding to, for example, the Education, and a portion of information on a content corresponding to, for example, the Cook.

The display apparatus 100 may, for example, detect a signal based on a motion of a control subject. The motion of the control subject may, for example, be a motion of a remote controller, but is not limited thereto, and the motion of the control subject may, for example, be a hand gesture. For example, the display apparatus 100 may include a camera and may detect a signal based on a particular motion or a particular change of look by sensing a hand gesture or a face of a user. In addition, the display apparatus 100 may detect a signal based on a manipulation of a touch pad of a remote controller.

In response to a signal based on a predetermined motion of a control subject being detected while information is provided, the display apparatus 100 may change an amount of displayed information and provide the information. For example, as described in the above example, the display apparatus 100 may display five pieces of content information which respectively belong to each category or may display ten pieces of content information which respectively belong to each category while the main category is selected. That is, the display apparatus 100 may change the amount of the displayed information and display the information based on the signal based on the predetermined motion of the control subject.

As described above, the display apparatus 100 may change the amount of the displayed information by detecting a motion of the control subject, and thus, a user is able to select and use a desired content faster and more effectively.

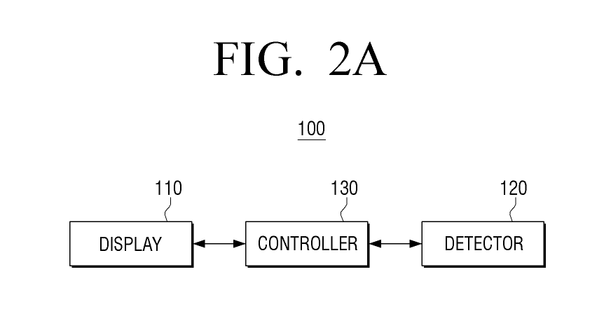

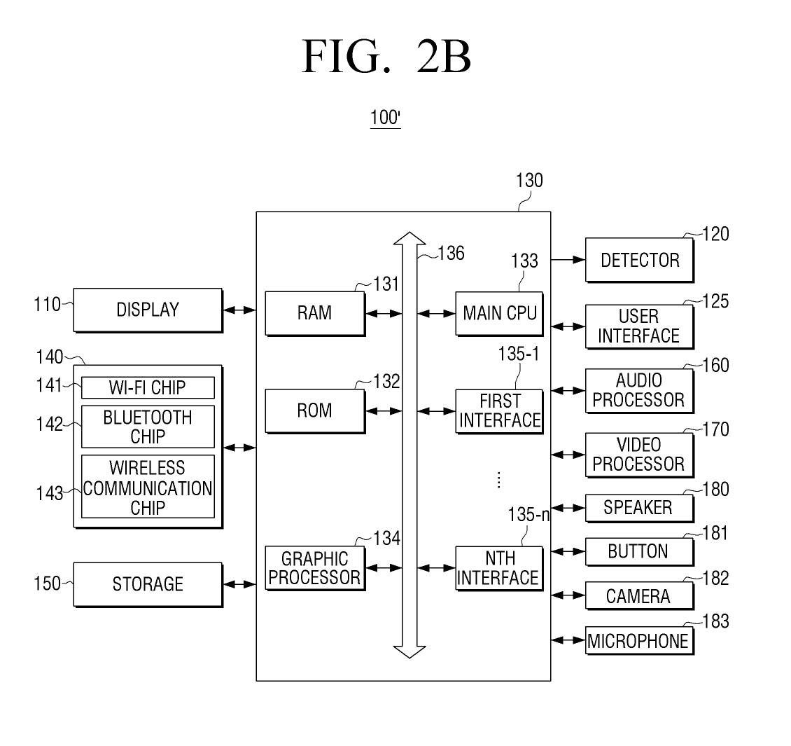

FIGS. 2A-2B are block diagrams illustrating a structure of the display apparatus 100 according to an example embodiment.

Referring to FIG. 2A, the display apparatus 100 includes a display 110, a detector 120, such as, for example, a motion detector, and a controller 130.

FIG. 2A comprehensively illustrates various components of the display apparatus 100 by taking a case where the display apparatus 100 includes various functions, such as, a display function, a communication function, a storage function, etc., as an example. Accordingly, the components illustrated in FIG. 2A may be partly omitted or modified, or other components may be added.

The display 110 provides information based on control of the controller 130. In addition, the display 110 may provide information by distinguishing depths, may provide information on a particular depth, or may provide the information on the particular depth along with a part of information corresponding to a lower depth of the particular depth. For example, while a UI screen including Movie, Cook, and Sports is displayed, the display apparatus 100 may additionally provide information, such as, Action and Romance as a lower depth of Movie, Dessert and Night snack as a lower depth of Cook, Short track and Football as a lower depth of Sports, etc.

The display 110 may be realized as, for example, a liquid crystal display (LCD) panel, organic light emitting diodes (OLED), etc, but is not limited thereto. In addition, the display 110 may be realized as a flexible display, a transparent display, etc.

The detector 120 may be configured to detect a signal based on a motion of a control subject. The control subject may, for example, be a remote controller or a user.

To be specific, the detector 120 may detect a signal based on a motion of the remote controller, but is not limited thereto, and the detector 120 may detect a hand gesture of a user. In response to a user using a remote controller, the detector 120 may detect a signal based on a motion of the remote controller, but is not limited thereto. That is, the detector 120 may detect the motion of the remote controller directly and generate a control signal based on the detected motion. In addition, based on a user motion of manipulating a touch pad of the remote controller, the remote controller may generate a control signal, and the detector 120 may detect the generated control signal. Meanwhile, the detector 120 may include a camera in order to detect, for example, a hand gesture of the control subject. For example, the detector 120 may detect a change of look of the user through the camera and generate a control signal based on the detected change of look.

In response to the signal based on the predetermined motion of the control subject being detected, the controller 130 may change the amount of the displayed information and provide the information.

The detector 120 may receive a signal corresponding to a motion of a remote controller having a motion sensor. In response to a signal based on a forward motion or a backward motion of the remote controller being received, the controller 130 may change the amount of the displayed information and provide the information.

The signal corresponding to the motion of the remote controller may be a signal corresponding to a predetermined motion of the remote controller which was detected while a predetermined button of the remote controller is pressed.

In addition, the detector 120 may receive a signal from a remote controller having a touch pad. In response to a signal based on a swipe interaction or other gesture on the touch pad being received, the controller 130 may change the amount of the displayed information and provide the information.

The detector 120 may detect a user motion. In response to a forward motion or a backward motion of the user being detected, the controller 130 may change the amount of the displayed information and provide the information.

The amount of the displayed information may include, for example, at least one of the number, a size, and specific information of a content

The specific information of the content may include, for example, at least one of a thumbnail, a title, a genre, and summary information of a content. In addition, in response to the number of the content being changed, the controller 130 may change the size and the specific information of the content and provide the content based on the changed number of the content.

The controller 130 may determine the amount of the displayed information which varies depending upon the detected signal based on at least one of resolution information and size information on a screen of the display apparatus 100.

The display 110 may provide a screen having a depth structure. In addition, in response to the signal based on the predetermined motion of the control subject being detected while the amount of the displayed information satisfies a predetermined condition, the controller 130 may change a depth and provide information corresponding to the changed depth.

The depth structure may include, for example, a main category, a sub category provided in the main category, and a content provided in the sub category.

FIG. 2B is a block diagram illustrating a structure of a display apparatus 100′ according to an example embodiment. Referring to FIG. 2B, the display apparatus 100′ includes, for example, the display 110, the detector 120, a user interface 125, the controller 130, a communicator 140, a storage 150, an audio processor 160, a video processor 170, a speaker 180, a button 181, a camera 182, and a microphone 183. FIG. 2B illustrates some components which are overlapped with the components of FIG. 2A, and thus, the detailed description on the overlapped components is omitted.

The controller 130 controls overall operations of the display apparatus 100 by using various programs stored, for example, in the storage 150.

For example, the controller 130 may include a Random Access Memory (RAM) 131, a Read-Only Memory (ROM) 132, a main Central Processing Unit (CPU) 133, a graphic processor 134, a first to n interfaces 135-1 to 135-n, and a bus 136.

The RAM 131, the ROM 132, the main CPU 133, the graphic processor 134, and the first to nth interfaces 135-1 to 135-n may be interconnected through the bus 136.

The first to nth interfaces 135-1 to 135-n are connected to the aforementioned various components. One of the interfaces may be a network interface which is connected to an external apparatus through a network.

For example, the main CPU 133 accesses the storage 150 and performs a booting operation using an operating system (0/S) stored in the storage 150. In addition, the main CPU 133 performs diverse operations using various programs stored in the storage 150.

The ROM 132 stores a set of commands for system booting. In response to a turn-on command being input and power being supplied, the main CPU 133 copies the O/S stored in the storage 150 into the RAM 131 according to a command stored in the ROM 132, and boots up a system by executing the O/S. In response to completion of the boot-up operation, the main CPU 133 copies various application programs stored in the storage 150 into the RAM 131, and executes the application programs copied into the RAM 131 to perform various operations.

The graphic processor 134 generates a screen including various objects, such as, icon, image, text, etc., using a computing unit (not shown) and a rendering unit (not shown). The computing unit computes property values, such as, coordinates, shape, size, and color of each object to be displayed, based on the layout of the screen based on the received control command. The rendering unit (not shown) generates a screen with various layouts including objects based on the property values computed by the computing unit. The screen generated by the rendering unit is displayed in a display area of the display 110.

Meanwhile, the above described operations of the controller 130 may be performed by the programs stored in the storage 150.

The storage 150 stores various data for operating the display apparatus 100, such as, an O/S software module, various depth information, information provided in a particular depth, layout information, etc.

In this case, the controller 130 may display information provided in a depth based on the information stored in the storage 150.

The user interface 125 receives various user interactions. In this case, the user interface 125 may be realized in diverse forms according to an example embodiment of the display apparatus 100. For example, in response to the display apparatus 100 being realized as a digital TV, the user interface 125 may be realized as a remote control receiver which receives a remote control signal from a remote controller, a microphone which receives a user voice, etc. In addition, in response to the display apparatus 100 being realized as, for example, a touch-based mobile device, the user interface 125 may be realized as a touch screen which forms a mutual layer structure with a touch pad. In this case, the user interface 125 may be used as the above described display 110.

A sensor (not shown) includes a touch sensor, a geomagnetic sensor, a gyro sensor, an acceleration sensor, a proximity sensor, a grip sensor, etc. The sensor may sense various manipulations, such as, rotation, gradient, pressure, approach, grip, and the like, on top of the touch.

The touch sensor may be realized as various types of touch sensor, such as, a capacitive type sensor or a pressure-resistive type sensor. The capacitive type refers to a method of sensing micro electricity which is excited into a user's body in response to a touch of a part of the user's body with respect to a surface of a display and calculating a touch coordinate based on the sensed micro electricity. The pressure-resistive type refers to a method of embedding two electrode plates into the display apparatus 100, sensing a current which flows when the two electrode plates, that is, an upper plate and a lower plate on a touched point that a user touched, come into contact with each other, and calculating a touch coordinate. Other than the above, a touch interaction may be sensed by an infrared sensing type, an acoustic surface wave conduction type, an integral tension measurement type, a piezoelectric effect type, etc.

In addition, the display apparatus 100 may determine whether a touch object, such as, a user finger, a stylus pen, etc., approaches or comes into contact with the display apparatus 100, by using a magnetic filed sensor, an optical sensor, or a proximity sensor instead of the touch sensor.

A geomagnetic sensor senses a rotation state or a moving direction of the display apparatus 100. The gyro sensor senses a rotation angle of the display apparatus 100. The display apparatus 100 may include both of the geomagnetic sensor and the gyro sensor, and the display apparatus 100 may sense a rotation state by using only one of the geomagnetic sensor and the gyro sensor.

An acceleration senses a gradient of the display apparatus 100.

A proximity sensor senses a motion of approaching a display without directly coming into contact with a surface of a display. The proximity sensor may be realized as various types of sensor, such as, a high-frequency oscillation-type proximity sensor which forms a high-frequency magnetic field to sense a current induced by a characteristic of the magnetic field which varies as a reaction against an approaching object, a magnetic type proximity sensor which uses a magnet, a capacitive type proximity sensor which senses capacitance which varies as a reaction against an approaching object, etc.

A grip sensor senses a user grip. The grip sensor is disposed on a rear surface, an edge, or a handle separately from a touch sensor on a touch screen. The grip sensor may be realized as a touch sensor or may be realized as a pressure sensor.

The audio processor 160 processes audio data. The audio processor 160 may, for example, perform various processing operations such as decoding, amplification, noise filtering and the like with respect to audio data.

The video processor 170 processes video data. The video processor 170 may, for example, perform various image processing operations such as decoding, scaling, noise filtering, frame rate conversion, resolution conversion, and the like with respect to video data.

The speaker 180 outputs various notification sounds, a voice message, etc., as well as various audio data processed by the audio processor 160.

The button 181 may realized as various types of buttons, such as, a mechanical button, a touch pad, a wheel, and the like which is disposed on an arbitrary area including a front surface, a side surface, or a rear surface of an appearance of a main body of the display apparatus 100.

The camera 182 photographs a still image or a moving image based on user control. The display apparatus 100 may include a plurality of cameras such as a front camera, a rear camera, etc. For example, the camera 182 may be used for photographing a motion of a control subject.

The microphone 183 receives and converts a user voice or other sounds into audio data.

The detailed description on a basic configuration and various example embodiments will be provided below.

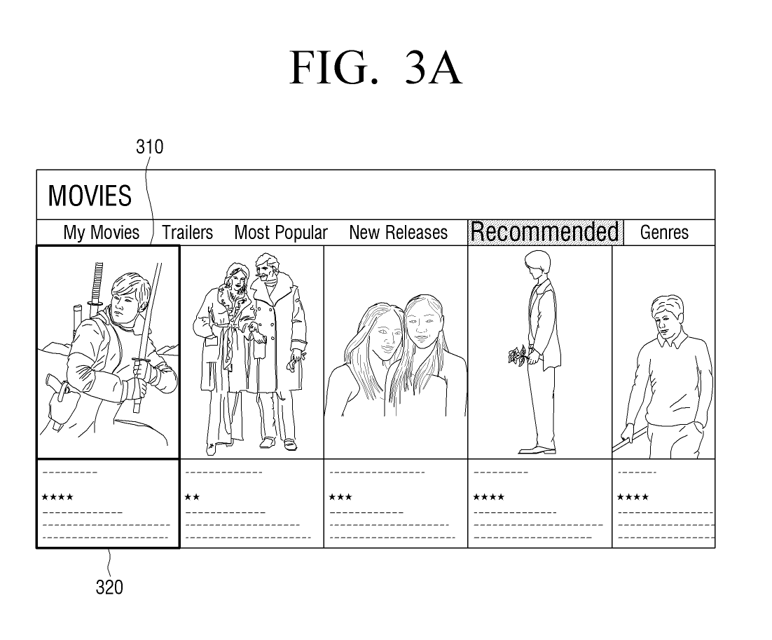

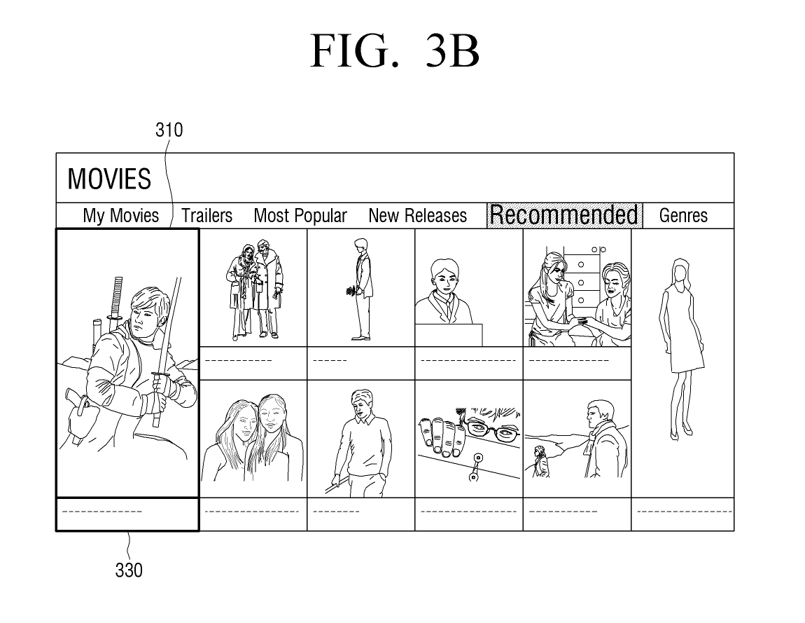

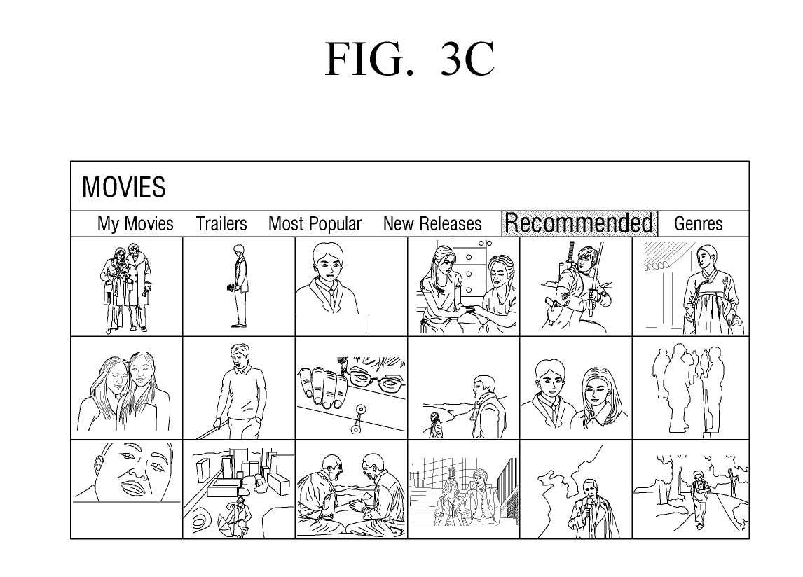

FIGS. 3A-3C are views provided to describe an operation of changing an amount of the displayed information and providing the information according to an example embodiment. In FIGS. 3A-3C, a main category may be divided into Movie, Education, Cook, etc., and a sub category of a ‘Movie’ category may be divided into My movies, Trailers, Most popular, New releases, Recommended, Genres, etc. It is assumed, for purposes of example, that a user selects the ‘Movie’ from the main category and selects ‘Recommended’ from the sub category. FIG. 3A is a view provided to describe an operation of providing the displayed information according to an example embodiment. According to the example illustrated in FIG. 3A, the controller 130 may, for example, display five contents, and each of the contents may include a corresponding thumbnail and information. A thumbnail 310 of a first content which is located in the leftmost place from among the five contents and information corresponding to the first content will be described. The description on the first content may be applied to the other four contents in the same manner.

The controller 130 may enlarge and display the thumbnail 310 of the first content. The controller 130 may display the thumbnail 310 in order to enhance user visibility since only five contents are displayed, but is not limited thereto. For example, the controller 130 may reduce the thumbnail 310 of the first content and display information 320 corresponding to the first content.

In addition, the controller 130 may display the thumbnail 310 of the first content, but is not limited thereto. For example, the controller 130 may display an image which is not the thumbnail 310 or may display a trailer repeatedly.

The information 320 corresponding to the first content may be specific information on a content. The specific information on a content may include at least one of a thumbnail, a title, a genre, and summary information of a content, etc. As illustrated in FIG. 3A, in response to a relatively small number of contents being displayed, the specific information of the content may include various information. In response to a large number of contents being displayed, the specific information of the content may include only a part of information. For example, in response to a small number of contents being displayed, all of the thumbnail, the title, the genre, and the summary information of the content may be displayed as the specific information. However, in response to a large number of contents being displayed, only the title and the summary information of the content may be displayed, for example, as the specific information or no one may be displayed.

FIG. 3B is a view provided to describe an operation of providing the displayed information according to another example embodiment. In response to the signal based on a predetermined motion of the control subject being detected while the information is provided, the controller 130 may change the amount of the displayed information and provide the information. For example, FIG. 3B illustrates a screen in which the amount of the displayed information is changed based on the signal based on the predetermined motion of the control subject as compared with the screen illustrated in FIG. 3A. The detailed description on the predetermined motion of the control subject will be provided below.

The controller 130 may change and display at least one of the number, the size, and the specific information of the content as the changed amount of information.

As described above, the specific information of the content may include, for example, at least one of the thumbnail, the title, the genre, and the summary information of a content. In addition, in response to the number of the content being changed, the controller 130 may change the size and the specific information of the content and provide the content based on the changed number of the content.

For example, according to FIG. 3B, the controller 130 may display ten contents in a depth which is the same as in FIG. 3A. In this case, the controller 130 may display the thumbnails of the contents to be smaller than the thumbnails of the five contents illustrated in FIG. 3A. In addition, in this case, the controller 130 may display less information 330 corresponding the first content than the amount of the five contents, but is not limited thereto. The controller 130 may display the information 330 corresponding to the first content in the same amount by, for example, reducing only a font size.

Meanwhile, referring to FIG. 3B, two contents are displayed by relatively large thumbnails, but is not limited thereto. Such layout may be set by a manufacturer or a user. In addition, the controller 130 may display thumbnails in the same size.

FIG. 3C is a view provided to described an operation of providing the displayed information according to still another example embodiment. In response to a signal based on the predetermined motion of the control subject being detected while the information is provided, the controller 130 may change the amount of the displayed information and provide the information. For example, FIG. 3C illustrates a screen in which the provided amount of information is changed based on the signal based on the predetermined motion of the control subject as compared with the screen illustrated in FIG. 3B, but is not limited thereto. That is, the screen of FIG. 3A may be directly changed to the screen of FIG. 3C based on, for example, at least one of the resolution information and the size information of the screen of the display apparatus 100. The detailed description of the example embodiment will be provided below.

According to FIG. 3C, in the same content category as illustrated in FIGS. 3A and 3B, the controller 130 may display, for example, eighteen contents. In addition, the controller 130 may not display information on the contents, but is not limited thereto. The controller 130 may, for example, display a part of information on the contents, reduce the thumbnails of the contents, or overlap and display the information on the contents with the thumbnails of the content. In addition, the controller 130 may reduce a size of the thumbnails to be much smaller and display more contents.

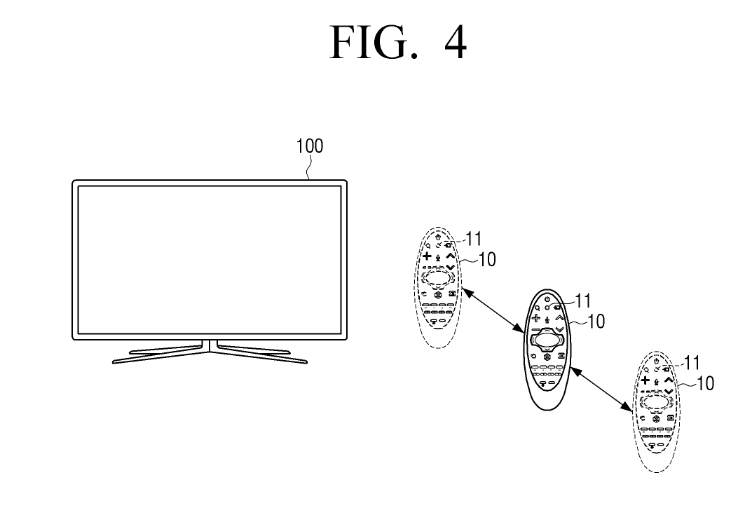

As above, the example embodiment of changing the amount of the displayed information based on a motion of a control subject has been described. A motion of the control subject will be described in detail with reference to FIGS. 4 to 6.

FIG. 4 is a view provided to describe a motion of a control subject according to an example embodiment.

According to FIG. 4, the detector 120 receives a signal corresponding to a motion of a remote controller 10 having a motion sensor. In response to a signal based on a forward motion or a backward motion of the remote controller 10 being received, the controller 130 may change the amount of the displayed information and provide the information.

The detector 120 may detect a signal corresponding to a motion of the remote controller 10. For example, the remote controller 10 may include a geomagnetic sensor for sensing a moving direction. In response to a moving direction being, for example, a direction of receding from the display apparatus 100, the remote controller 10 may generate a control signal so that the number of displayed contents decreases and the amount of information on the contents increases. In addition, in response to the moving direction being, for example, a direction of approaching the display apparatus 100, the remote controller 10 may generate a control signal so that the number of displayed contents increases and the amount of information on the contents decreases. The detector 120 may detect the generated control signal.

In addition, the remote controller 10 may include a gyro sensor for sensing a rotation state. The remote controller 10 may, for example, sense a rotation state in a clockwise direction and generate a control signal so that the number of displayed contents decreases and the amount of information on the contents increases. In addition, the remote controller 10 may sense a rotation state in a counterclockwise direction and generate a control signal so that the number of displayed contents increases and the amount of information on the contents decreases. The detector 120 may detect the generated control signal.

According to another example embodiment, the detector 120 may detect a motion of the remote controller 10. For example, the detector 120 may detect a relative location with respect to the display apparatus 100, and the controller 130 may generate a control signal based on the detected motion. For example, in response to a motion that the remote controller 10 recedes from the display apparatus 100 being detected, the controller 130 may decrease the number of displayed contents and increase the amount of information of the contents based on the detected motion of the remote controller 10. In order to detect a motion of the remote controller 10, the detector 120 may include a camera. The detailed description of the camera will be provided below. In addition, the display apparatus 100 may generate a control signal based on a relative location of the remote controller 10 with respect to a user, as well as the relative location of the remote controller 10 with respect to the display apparatus 100. For example, in response to a motion that the remote controller 10 approaches the user being detected, the controller 130 may enlarge the displayed content, and in response to a motion that the remote controller 10 recedes from the user being detected, the controller 130 may reduce the displayed content, but is not limited thereto. For example, in response to the motion that that the remote controller 10 approaches the user being detected, the controller 130 may reduce the displayed content. In addition, the controller 130 may generate a control command based on a distance between the remote controller 10 and a face of the user. Alternatively, the remote controller 10 may directly generate and transmit a control command.

The signal corresponding to the motion of the remote controller 10 may be a signal corresponding to a predetermined motion of the remote controller 41 detected while a predetermined button 11 of the remote controller 10 is pressed. In response to the motion of the remote controller 10 being detected while the predetermined button 11 is not pressed, the controller 130 may generate a control signal based on a motion of the remote controller that the user did not intend. Accordingly, the controller 130 may detect a motion of the remote controller 10 only when the predetermined button 11 of the remote controller 10 is pressed so as to enhance the user convenience, but is not limited thereto. For example, the controller 130 may detect the motion of the remote controller 10 when a touch manipulation is performed with respect to a touch pad, not the predetermined button 11.

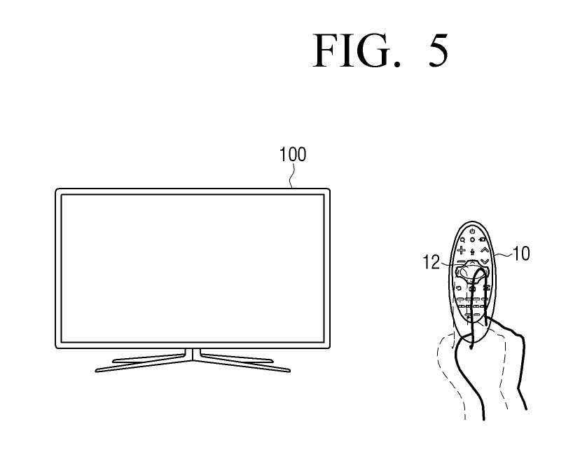

FIG. 5 is a view provided to describe a motion of a control subject according to another example embodiment.

Referring to FIG. 5, the detector 120 may receive a signal from a remote controller having a touch pad 12. In response to a signal based on, for example, a swipe interaction or other gesture on the touch pad 12 being received, the controller 130 may change an amount of displayed information and provide the information.

The swipe interaction refers to an interaction of touching a particular point with a finger and swiping the finger across the touch pad 12 in a certain direction without taking the finger off the touch pad 12. The control subject may perform a slide touch operation of touching a particular point in the touch pad 12 and sliding on the touch pad without taking the finger off, and may perform various control operations in a direction of a touch start point and a touch direction on the touch pad 12. For example, in response to a lower part of the touch pad being a touch start point and a swipe interaction being received in a upward direction from the touch start point, the controller 130 may increase the amount of displayed information. By contrast, in response to an upper part of the touch pad 12 being the touch start point and the swipe interaction being received in a downward direction from the touch point, the controller 130 may decrease the amount of displayed information.

In response to the swipe interaction being received, the detector 120 detects a signal based on a motion of the control subject, that is, the swipe interaction. In response to the motion of the control subject, that is, the swipe interaction being received, the remote controller 10 may generate a control signal and transmit the generated control signal to the display apparatus 100, but is not limited thereto. The remote controller 10 may transmit only a signal in which a touch point varies depending upon the swipe interaction to the display apparatus 100, and the display apparatus 100 may generate a control command based on the detected signal.

In response to the amount of information being changed by a swipe interaction in the upward direction or the downward direction, the controller 130 may execute a particular content or change a focus displayed in the display 110 through an interaction in a horizontal direction.

Meanwhile, in FIGS. 4 and 5, the control command is generated based on the motion of the remote controller and the motion of the control subject on the touch pad, but is not limited thereto. For example, in response to the remote controller 10 including sensors on both edges thereof, the remote controller 10 may change the amount of displayed information through a touch of the control subject. In addition, in response to the predetermined button being touched and a signal based on the motion of the control subject being detected, the remote controller 10 may adjust a degree of change of the amount of information. For example, in response to the predetermined button being touched and the signal based on the motion of the control subject being detected, the controller 130 may change the amount of information and provide the information as illustrated in FIG. 3C, from the state of FIG. 3A.

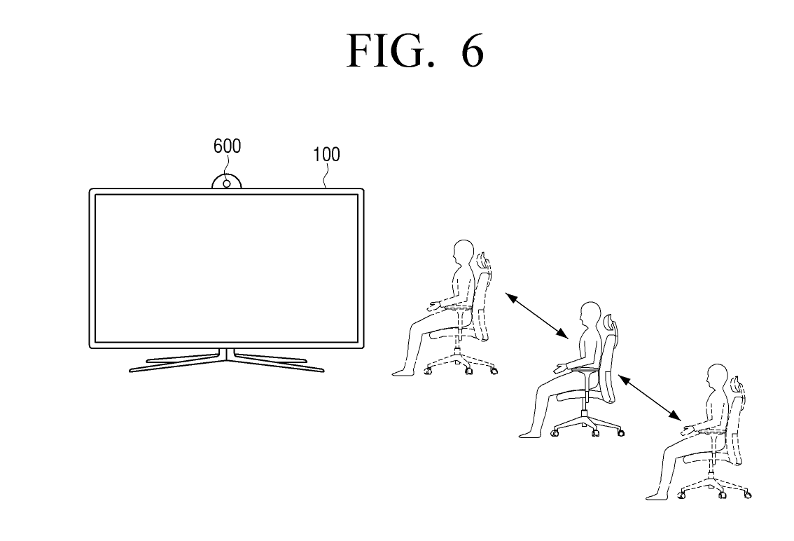

FIG. 6 is a view provided to describe a motion of a control subject according to another example embodiment.

Referring to FIG. 6, the detector 120 may detect a user motion. In response to the forward motion or the backward motion of the user being detected, the controller 130 may change the amount of displayed information and provide the information.

The user motion may include a motion of approaching the display apparatus 100 and a motion of receding from the display apparatus 100. The display apparatus 100 may further include a camera 600 in order to detect the user motion. The user motion may be photographed by the camera 600, and the controller 130 may change the amount of displayed information and provide the information based on the user motion. In addition, the user motion may be a hand gesture of the user. For example, the camera 600 may recognize a hand of the user, and the controller 130 may increase or decrease the amount of displayed information based on, for example, a motion of pushing and pulling the hand of the user.

The controller 130 may display the hand gesture of the user in the display 110. For example, in case of converting a page, the controller 130 may display a UI screen of pushing and converting the page with a finger as though the user reads a book.

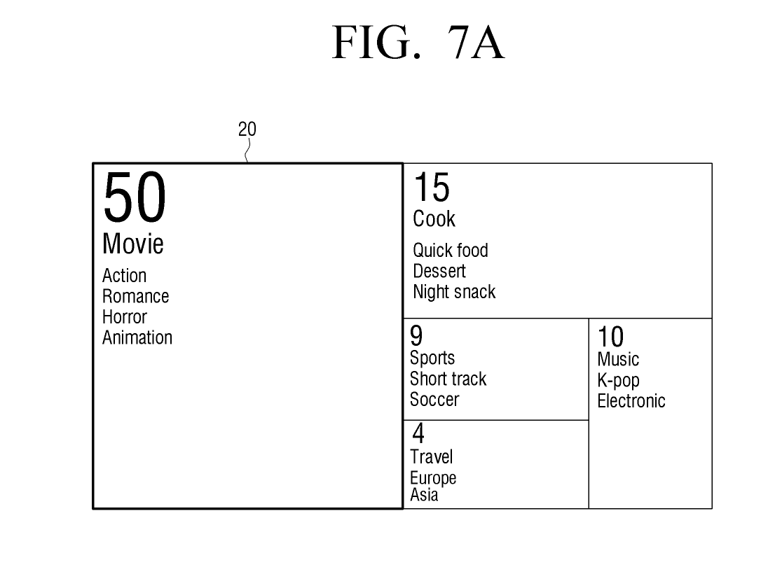

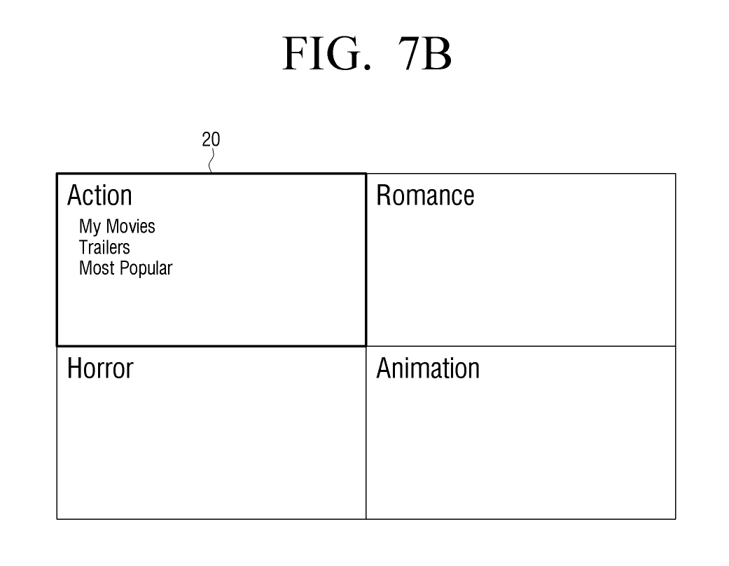

FIGS. 7A-7B are views provided to describe an operation of changing a depth according to an example embodiment.

FIG. 7A is view provided to describe an operation of displaying information provided in an upper depth according to an example embodiment. Referring to FIG. 7A, the display 110 provides a screen having a depth structure. In response to the signal based on the predetermined motion of the control subject being detected while the amount of displayed information satisfies the predetermined condition, the controller 130 may change a depth and provide information corresponding to the changed depth.

For example, the depth structure may include a main category, a sub category provided in the main category, and a content provided in the sub category, but is not limited thereto. The sub category may provide another sub category.

The predetermined condition may be determined based on at least one of the resolution information and the size information on the screen of the display apparatus 100. For example, in response to the signal based on the predetermined motion of the control subject being detected while the display apparatus 100 having certain resolution displays five types of categories to a minimum as illustrated in FIG. 7A, the depth may be changed as illustrated in FIG. 7B.

The user is able to move channel 50 which belongs to a movie channel to the largest screen in the leftmost place through a manipulation of a direction key. In this case, in response to the signal based on the predetermined motion of the control subject being detected, the controller 130 may display a larger number of categories or display a fewer number of categories based on the detected signal. In response to the display apparatus 100 being set to display five types of categories at a minimum, the display apparatus 100 may not display a fewer number of categories, and the controller 130 may change a depth to a lower depth, but is not limited thereto, and the depth may not be changed until a category is displayed.

In addition, in response to the display apparatus 100 being set to display five types of categories to a maximum, the display apparatus 100 may not display a larger number of categories, and the controller 130 may change a depth to an upper depth, but is not limited thereto, and a limit of the number of categories may be set differently.

In the above description, when a depth is changed to a lower depth with reference to the leftmost place, the depth is changed to a lower depth of a category in the leftmost place, but is not limited thereto. For example, a category in the rightmost place may be a reference category, or a focus 20 may be displayed to change the reference category through the user manipulation of a direction key.

FIG. 7B is a view provided to describe an operation of displaying information provided in a lower depth according to an example embodiment. Referring to FIG. 7B, a sub category provided in the Movie category of FIG. 7A is displayed, and the controller 130 may display Action, Romance, Horror, Animation, etc.

As described above, in response to a signal based on the predetermined motion of the control subject being detected, the controller 130 may change the amount of displayed information and provide the information. In addition, the controller 130 may display only Action and Romance or may further display Martial art, War, Fantasy, etc.

The controller 130 may display a part of information on a lower depth provided in a sub category in the sub category in which the focus 20 is located, but is not limited thereto. The controller 130 may not display the information on the lower depth or may display the information on the lower depth in the sub category in which the focus 20 is not located.

For example, while a UI screen regarding an upper category is displayed, the controller 130 may display information on a lower category as information corresponding to the upper category. For example, while a UI screen regarding a main category is displayed, the controller 130 may display information on a sub category as information corresponding to the main category.

In FIGS. 7A-7B, the depth structure and the operation of changing a depth are described, but the example embodiment is not limited thereto. For example, it may be seen that a plurality of categories belong to the displayed information, and in a broad sense, it may be seen that changing an amount of displayed information includes a change of a plurality of categories. Accordingly, the operation of changing the amount of displayed information may include changing the number of contents and changing a category.

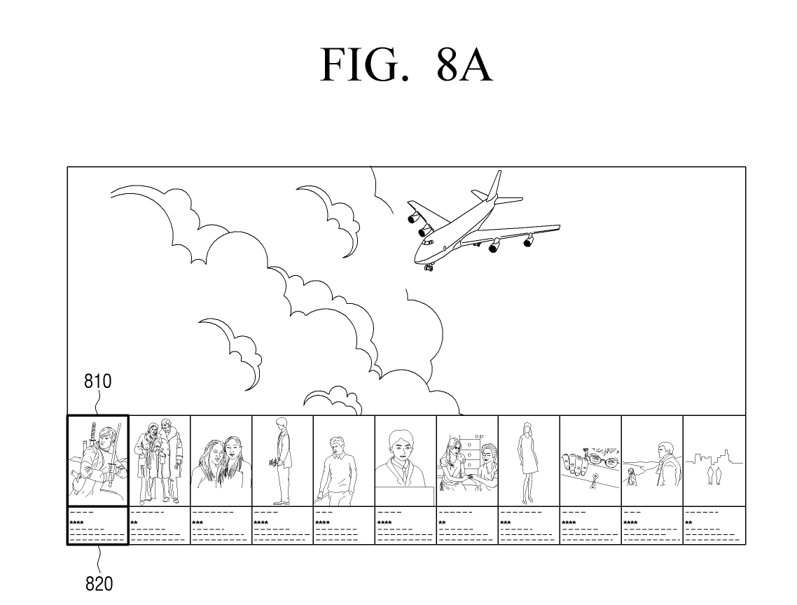

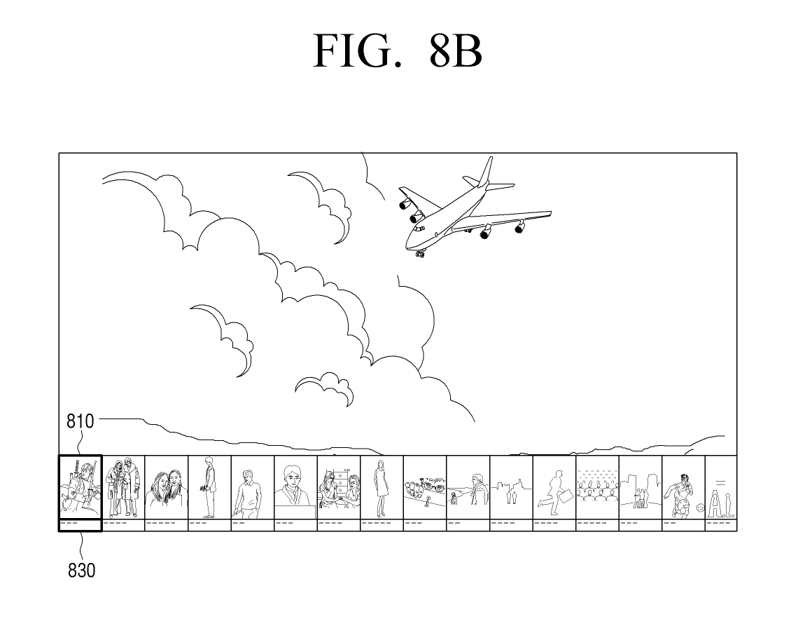

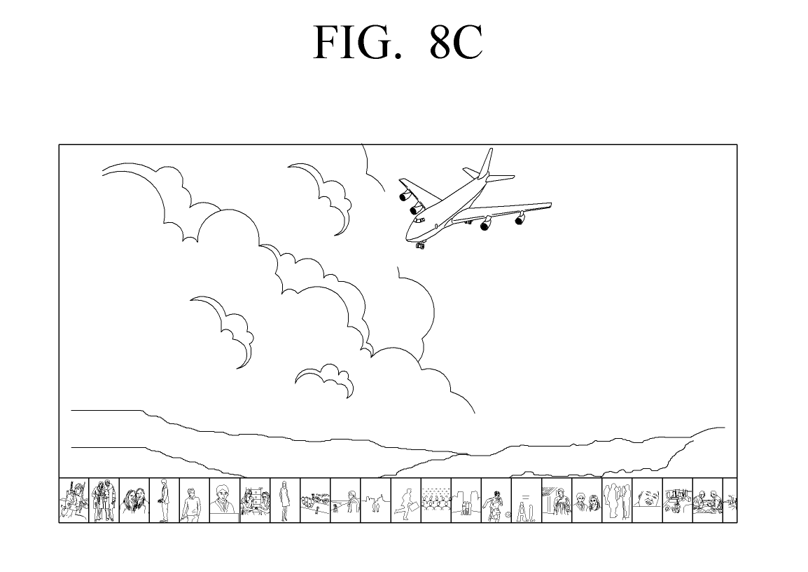

FIGS. 8A-8C are views provided to describe an operation of changing an amount of displayed information and providing the information according to an example embodiment.

Referring to FIG. 8A, while a particular content is displayed, the controller 130 may, for example, provide displayed information in an overlapped manner according to a type of the display apparatus 100 or a user setting. For example, in FIGS. 3A-3C, the controller 130 displays only a plurality of contents provided by the display apparatus 100 and information corresponding to each of the plurality of contents. However, in FIG. 8, the controller 130 may display a content providing screen in a part of the display 110 while a user watches a movie so as to provide the information on the content while reducing an interruption with respect to the user.

FIGS. 8A to 8C are views provided to describe an example operation of changing an amount of displayed information and providing the information. The descriptions on a thumbnail 810 of a first content and information 820 corresponding to the first content in FIG. 8A and a thumbnail 810 of a first content and information 830 corresponding to the first content in FIG. 8B are the same as the description of FIGS. 3A-3C, and thus, the overlapped description is omitted.

The user is able to activate a UI screen for changing a content while a particular content is displayed. In this case, the controller 130 may display a depth when the currently displayed content was selected and information provided in the depth, but is not limited thereto. The controller 130 may display a uppermost depth.

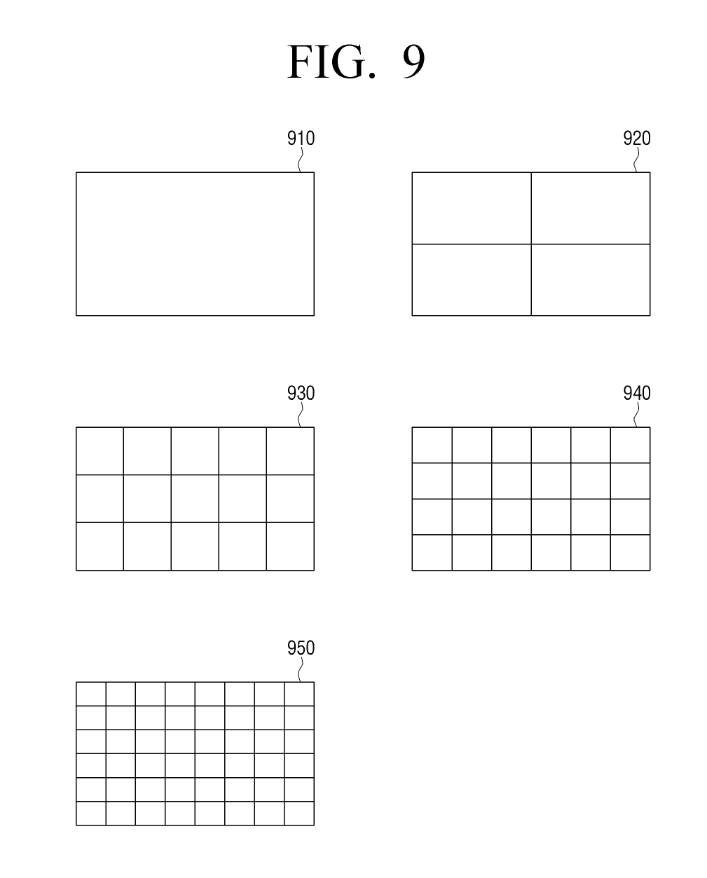

FIG. 9 is a view provided to describe an operation of selecting a layout according to an example embodiment.

Referring to FIG. 9, the controller 130 may determine an amount of information which varies depending upon a detected signal based on at least one of the resolution information and size information on the screen of the display apparatus 100. The information may be displayed based on a predetermined layout. For example, the display apparatus 100 may store a plurality of layouts 910 to 950, and the controller 130 may display a content and information on the content based on any one of the plurality of layouts 910 to 950. A first layout 910 may display only one content, and a second layout 920 may display four contents, etc. It is assumed, for example, that the number of displayed contents increases based on an order of the contents, and thus, a fifth layout 950 displays forty-eight contents.

An example embodiment in which the controller 130 displays a content and information on the content based on the resolution information on the screen of the display apparatus 100 will be provided. In response to the display apparatus 100 having high resolution, the controller 130 may provide a user with a clear image quality even when displaying a large number of contents, and thus, the controller 130 may use all of the first layout 910 to the fifth layout 950. In response to the display apparatus 100 having low resolution, the controller 130 may not provide the user with the clear image quality when displaying a large number of contents, and thus, the controller 130 may use the first layout 910 to the third layout 930. For example, in response to the resolution of the screen being high definition (HD), the controller 130 may use the first layout 910 and the second layout 920. In response to the resolution of the screen being full high definition (FHD), the controller 130 may use the first layout 910 to the fourth layout 940, etc.

The controller 130 may display the content and the information on the content based on the size information on the screen of the display apparatus 100. In response to the display apparatus 100 having a large screen, the controller 130 may provide the user with the clear image quality even when displaying a large number of contents, and thus, the controller 130 may use all of the first layout 910 to the fifth layout 950. In response to the display apparatus 100 having a small screen, the controller 130 may not provide the user with the clear image quality when displaying a large number of contents, and thus, the controller 130 may use the first layout 910 to the fourth layout 940. For example, in response to the display apparatus 100 having a forty-inch screen, the controller 130 may use the first layout 910 to the third layout 930. In response to the display apparatus 100 having an eighty-inch screen, the controller 130 may use the first layout 910 to the fifth layout 950.

FIG. 9 illustrates five layouts, but the number of layouts are merely examples, and the number of layouts may be set differently by a manufacturer or a user. In addition, in FIG. 9, the layouts are displayed based on the number of contents for convenience in explanation, but the controller 130 may display information corresponding to other contents in each layout. In addition, the controller 130 may determine a layout based on both of the resolution information and the size information on the screen of the display apparatus 100. In addition, the controller 130 may not use the layouts in a sequential order. For example, the controller 130 may use the first layout 910, the second layout 920, and the fourth layout 940.

The manufacturer may set a plurality of layouts, and the controller 130 may determine an amount of information to be changed based on at least one of the resolution information and the size information on the screen of the display apparatus 100. Accordingly, there is no need to set a different layout for each display apparatus 100.

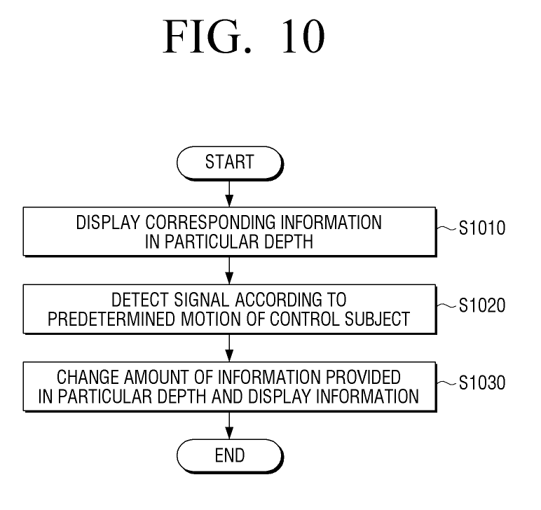

FIG. 10 is a flowchart provided to describe a method for controlling a display apparatus according to an example embodiment.

Referring to FIG. 10, the display apparatus 100 displays information (51010). Subsequently, the display apparatus 100 detects a signal based on a predetermined motion of a control subject (S1020). The display apparatus 100 changes an amount of displayed information and provides the information (S1030).

In response to a signal based on a forward motion or a backward motion being received from the remote controller 10 having a motion sensor, the changing the amount of displayed information (S1030) may include changing an amount of displayed information and providing the information.

The signal received from the remote controller 10 may be a signal corresponding to a predetermined motion of the remote controller 10 detected while a predetermined button of the remote controller 10 is pressed.

In response to a signal based on a swipe interaction or other gesture on a touch pad being received from the remote controller 10 having the touch pad, changing the amount of the information (S1030) may include changing the amount of the displayed information and providing the information.

In response to a forward motion or a backward motion of a user being detected, changing the amount of the information (S1030) may include changing the amount of the displayed information and providing the information.

The amount of the information may include, for example, at least one of the number, a size, and specific information of a content.

The specific information of the content may include at least one of a thumbnail, a title, a genre, and summary information of a content. In addition, in response to the number of content being changed, changing the amount of the information (S1030) may include changing the size and the specific information of the content and providing the content based on the changed number of the content.

Changing the amount of information (S1030) may include determining an amount of information which varies depending upon the detected signal based on at least one of resolution information and size information on a screen of the display apparatus 100.

The method may further include changing, in response to a signal based on a predetermined motion of the control subject being detected while the amount of the displayed information satisfies a predetermined condition, a depth and providing information corresponding to the changed depth.

The depth structure may include a main category, a sub category provided in the main category, and a content provided in the sub category.

According to various example embodiments, a display apparatus detects a signal based on a motion of a control subject, changes an amount of displayed information, and provides the information. Accordingly, user convenience may be enhanced since a user is able to change the amount of information through a more simple manipulation.

Meanwhile, the methods according to above described example embodiments may be programmed and stored in various recording medium. Accordingly, the methods may be implemented in diverse types of electronic apparatuses which executes a recording medium. For example, as described above, and will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

For example, a non-transitory computer readable medium including a program for sequentially performing displaying information and changing an amount of displayed information and providing the information in response to a signal based on a predetermined motion of a control subject may be provided.

The non-transitory computer readable medium refers to a medium which may store data permanently or semi-permanently rather than storing data for a short time such as a register, a cache, and a memory and may be readable by an apparatus. As an example, the above-described various applications and programs may be stored in the non-transitory computer readable medium such as a compact disc (CD), a digital versatile disk (DVD), a hard disk, a Blu-ray disk, a universal serial bus (USB), a memory card, a read-only memory (ROM), and the like, and provided therein.

The foregoing example embodiments and advantages are merely examples and are not intended to be limiting. The present teaching can be readily applied to other types of devices. Also, the description of the example embodiments is intended to be illustrative, and not to limit the scope of the claims, and many alternatives, modifications, and variations will be apparent to those skilled in the art.

What is claimed is:

1. A display apparatus comprising:
a display configured to display information;
a detector configured to detect a signal based on a motion of a control subject; and
a controller configured to, in response to a signal based on a predetermined motion of the control subject being detected, control the display to change an amount of the displayed information and provide the information.

2. The apparatus as claimed in claim 1, wherein the detector receives a signal corresponding to a motion of a remote controller having a motion sensor,
wherein in response to a signal based on a forward motion or a backward motion of the remote controller being received, the controller is configured to control the display to change the amount of the displayed information and provide the information.

3. The apparatus as claimed in claim 2, wherein the signal corresponding to the motion of the remote controller is a signal corresponding to a predetermined motion of the remote controller, the predetermined motion being detected while a predetermined button of the remote controller is pressed.

4. The apparatus as claimed in claim 1, wherein the detector receives a signal from a remote controller having a touch pad,
wherein the controller is configured to control the display to change the amount of the displayed information and provide the information in response to a signal based on a swipe interaction on the touch pad being received.

5. The apparatus as claimed in claim 1, wherein the detector detects a user motion,
wherein the controller is configured to control the display to change the amount of the displayed information and provide the information in response to a forward motion or a backward motion of a user being detected.

6. The apparatus as claimed in claim 1, wherein the amount of the displayed information comprises at least one of a number, a size, and specific information of a content.

7. The apparatus as claimed in claim 6, wherein the specific information of the content comprises at least one of a thumbnail, a title, a genre, and summary information of the content,
wherein the controller is configured to change the size and the specific information of the content and provides the content based on the changed number of the content in response to the number of the content being changed.

8. The apparatus as claimed in claim 1, wherein the controller is configured to determine an amount of information, wherein the amount of information varies depending upon the detected signal based on at least one of resolution information and size information on a screen of the display apparatus.

9. The apparatus as claimed in claim 1, wherein the display displays a screen having a depth structure,
wherein the controller is configured to change a depth and provides information corresponding to the changed depth in response to the signal based on the predetermined motion of the control subject being detected while the amount of the displayed information satisfies a predetermined condition.

10. The apparatus as claimed in claim 9, wherein the depth structure comprises a main category, a sub category provided in the main category, and a content provided in the sub category.

11. A method for controlling a display apparatus, comprising:
displaying information; and
changing an amount of the displayed information and providing the information, in response to a signal based on a predetermined motion of a control subject being detected.

12. The method as claimed in claim 11, wherein said changing an amount of the displayed information and providing the information is in response to a signal based on a forward motion or a backward motion being received from a remote controller having a motion sensor.

13. The method as claimed in claim 12, wherein the signal being received from the remote controller is a signal corresponding to a predetermined motion of the remote controller, the predetermined motion being detected while a predetermined button of the remote controller is pressed.

14. The method as claimed in claim 11, wherein said changing the amount of the displayed information and providing the information is in response to a signal based on a swipe interaction on a touch pad being received from a remote controller having the touch pad.

15. The method as claimed in claim 11, wherein said changing the amount of the displayed information and providing the information is in response to a forward motion or a backward motion of a user being detected.

16. The method as claimed in claim 11, wherein the amount of the displayed information comprises at least one of the number, a size, and specific information of a content.

17. The method as claimed in claim 16, wherein the specific information of the content comprises at least one of a thumbnail, a title, a genre, and summary information of a content,
wherein in response to the number of the content being changed, the changing the amount of the displayed information comprises changing the size and the specific information of the content and providing the content based on the changed number of the content.

18. The method as claimed in claim 11, wherein the changing the amount of the displayed information comprises determining an amount of information which varies depending upon the detected signal based on at least one of resolution information and size information on a screen of the display apparatus.

19. The method as claimed in claim 11, further comprising:
changing, in response to the signal based on the predetermined motion of the control subject being detected while the amount of the displayed information satisfies a predetermined condition, a depth and providing information corresponding to the changed depth.

20. The method as claimed in claim 19, wherein the depth structure comprises a main category, a sub category provided in the main category, and a content provided in the sub category.
